(19) United States
(12) Patent Application Publication
(10) Pub. No.: US 2026/0052506 A1
(43) Pub. Date: Feb. 19, 2026

(54) METHOD AND DEVICE FOR RANGING USING BLE COMMUNICATION AND UWB COMMUNICATION

(71) Applicant: Samsung Electronics Co., Ltd., Suwon-si (KR)

(72) Inventor: Mingyu LEE, Suwon-si (KR)

(21) Appl. No.: 19/300,831

(22) Filed: Aug. 15, 2025

(30) Foreign Application Priority Data
Aug. 19, 2024 (KR) 10-2024-0110782

(51) Int. Cl. H04W 64/00; H04B 1/7163; H04W 72/20

(52) U.S. Cl. CPC H04W 64/00; H04B 1/7163; H04W 72/20

(57) ABSTRACT

The disclosure discloses a method for operating both a UWB channel and an BLE channel. According to an embodiment, a method of a first ultra-wideband (UWB) device may comprise transmitting a control message to a second UWB device using Bluetooth low energy (BLE) communication in a control phase for UWB ranging, transmitting a first message to the second UWB device using UWB communication in a ranging phase for the UWB ranging, receiving a second message corresponding to the first message from the second UWB device using the UWB communication in the ranging phase for the UWB ranging, and transmitting a report message to the second UWB device using the BLE communication in a report phase for the UWB ranging.

### CROSS-REFERENCE TO RELATED APPLICATION

This application is based on and claims priority under 35 U.S.C. § 119 to Korean Patent Application No. 10-2024-0110782, which was filed in the Korean Intellectual Property Office on Aug. 19, 2024, the entire disclosure of which is incorporated herein by reference.

### BACKGROUND

### 1. Field

The disclosure relates to ultra-wideband (UWB) communication and, more specifically, to a Bluetooth low energy (BLE) communication-based UWB ranging method and a device performing the same.

### 2. Description of Related Art

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, healthcare, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wideband (UWB).

### SUMMARY

The disclosure provides a BLE communication-based UWB ranging method.

According to an embodiment, a method of a first ultra-wideband (UWB) device may comprise transmitting a control message to a second UWB device using Bluetooth low energy (BLE) communication in a control phase for UWB ranging, transmitting a first message to the second UWB device using UWB communication in a ranging phase for the UWB ranging, receiving a second message corresponding to the first message from the second UWB device using the UWB communication in the ranging phase for the UWB ranging, and transmitting a report message to the second UWB device using the BLE communication in a report phase for the UWB ranging.

According to an embodiment, a method of a second ultra-wideband (UWB) device may comprise receiving a control message from a first UWB device using Bluetooth low energy (BLE) communication in a control phase for UWB ranging, receiving a first message from the first UWB device using UWB communication in a ranging phase for the UWB ranging, transmitting a second message corresponding to the first message to the first UWB device using the UWB communication in the ranging phase for the UWB ranging, and receiving a report message from the first UWB device using the BLE communication in a report phase for the UWB ranging.

According to an embodiment, a first ultra-wideband (UWB) device may comprise a transceiver and a controller. The controller may control to transmit a control message to a second UWB device using Bluetooth low energy (BLE) communication in a control phase for UWB ranging, control to transmit a first message to the second UWB device using UWB communication in a ranging phase for the UWB ranging, receive a second message corresponding to the first message from the second UWB device using the UWB communication in the ranging phase for the UWB ranging, and control to transmit a report message to the second UWB device using the BLE communication in a report phase for the UWB ranging.

According to an embodiment, a second ultra-wideband (UWB) may comprise a transceiver and a controller. The controller may receive a control message from a first UWB device using Bluetooth low energy (BLE) communication in a control phase for UWB ranging, receive a first message from the first UWB device using UWB communication in a ranging phase for the UWB ranging, control to transmit a second message corresponding to the first message to the first UWB device using the UWB communication in the ranging phase for the UWB ranging, and receive a report message from the first UWB device using the BLE communication in a report phase for the UWB ranging.

The disclosure provides a method for enhancing the ranging performance of a UWB device by operating a UWB channel and a BLE channel together.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1A illustrates an example architecture of a UWB device according to an embodiment of the present disclosure;

FIG. 1B illustrates a communication system including a UWB device according to an embodiment of the present disclosure;

FIG. 2 illustrates a method for performing an NB procedure and a UWB procedure by a UWB device according to an embodiment of the present disclosure;

FIG. 3 illustrates an example of a structure of a ranging block and round used for UWB ranging according to an embodiment of the present disclosure;

FIG. 4A illustrates an example of a ranging round according to an embodiment of the present disclosure;

FIG. 4B illustrates an example of a control phase in a ranging round according to an embodiment of the present disclosure;

FIG. 4C illustrates an example of a report phase in a ranging round according to an embodiment of the present disclosure;

FIG. 4D illustrates an example of a ranging phase in a ranging round according to an embodiment of the present disclosure;

FIG. 5A illustrates an example of an initialization channel and a ranging channel according to an embodiment of the present disclosure;

FIG. 5B illustrates an example of a UWB setup process through an initialization channel according to an embodiment of the present disclosure;

FIG. 5C illustrates an example of a BLE setup process through an initialization channel according to an embodiment of the present disclosure;

FIG. 6 illustrates an example of a BLE session setup process according to an embodiment of the present disclosure;

FIG. 7A illustrates an example in which an advertising event and a connection event are performed on a BLE protocol according to an embodiment of the present disclosure;

FIG. 7B illustrates an example of a MD bit indicating whether there is more data transmitted by a device according to an embodiment of the present disclosure;

FIG. 8 illustrates an example of ranging using BLE communication and UWB communication according to an embodiment of the present disclosure;

FIGS. 9A and 9B illustrate an example of a method of replacing an NB on a BLE protocol according to an embodiment of the present disclosure;

FIG. 10 illustrates an example in which a plurality of slots are used as a BLE transmission period according to an embodiment of the present disclosure;

FIG. 11 illustrates an example of ranging using BLE communication and UWB communication according to an embodiment of the present disclosure;

FIG. 12A illustrates an example of devices for a CIS according to an embodiment of the present disclosure;

FIG. 12B illustrates an example of a CIS event according to an embodiment of the present disclosure;

FIG. 13 illustrates an example of ranging using BLE communication and UWB communication according to an embodiment of the present disclosure;

FIG. 14 illustrates an example of ranging using BLE communication and UWB communication according to an embodiment of the present disclosure;

FIG. 15 illustrates a structure of a first UWB device according to an embodiment of the present disclosure; and

FIG. 16 illustrates a structure of a second UWB device according to an embodiment of the disclosure.

### DETAILED DESCRIPTION

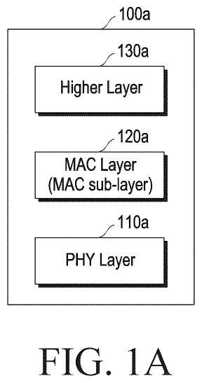

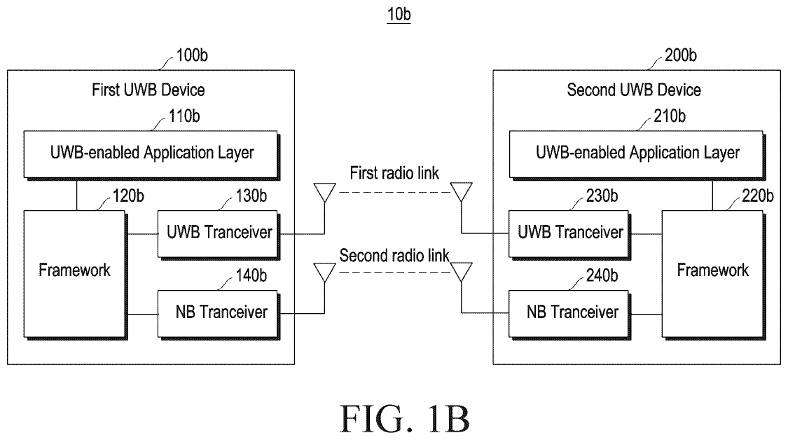

FIGS. 1A through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments of the disclosure, a “ . . . unit” may include one or more processors.

As used herein, the term “terminal” or “device” may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wideband (UWB). A wireless network in which such a wireless network technology is implemented may include a plurality of electronic devices. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Ranging device” may be a device capable of performing UWB ranging. In the disclosure, the ranging device may be a ranging device (RDEV) or enhanced ranging device (ERDEV) defined in, e.g., IEEE 802.15.4/4z. In the disclosure, the ranging device may be referred to as a UWB device.

“Advertiser” may be a device (e.g., ranging device) that transmits a message for discovery. For example, the advertiser may be a device that transmits (or broadcasts) an advertisement message through a mirroring (or initialization) channel or transmits (or broadcasts) a discovery beacon (message) through a discovery channel.

“Scanner” may be a device (e.g., ranging device) that receives a message for discovery. For example, the scanner may be a device that scans the mirroring channel to receive an advertisement message or scans the discovery channel to receives a discovery beacon (message). In this disclosure, the scanner may be referred to as an observer.

“Controller” may be a device (e.g., ranging device) that defines and controls ranging control messages (RCM) (or control messages).

“Controlee” may be a device (e.g., ranging device) using a ranging parameter in the RCM (or control message) received from the controller.

“Initiator” may be a device (e.g., ranging device) that initiates a ranging exchange.

“responder” may be a device (e.g., ranging device) that responds to the initiator in a ranging exchange.

“In-band” may be data communication that uses UWB as an underlying wireless technology.

“Out-of-band (OOB)” may be data communication that does not use UWB as an underlying wireless technology.

“UWB Session” may be a period from when the controller and the controlee start communication through UWB until the communication stops. In the UWB session, a ranging frame RFRAME may be transferred, a data frame may be transferred, or both a ranging frame and a data frame may be transferred.

“UWB session ID” may be an ID (e.g., a 32-bit integer) that identifies the UWB session, shared between the controller and the controller.

“UWB session key” may be a key used to protect the UWB Session. The UWB session key may be used to generate a scrambled timestamp sequence (STS). In this disclosure, the UWB session key may be a UWB ranging session key (URSK), and may be abbreviated as a session key.

“UWB subsystem (UWBS)” may be a hardware component implementing the UWB PHY and MAC specifications included in the UWB device. In this disclosure, the UWB PHY and MAC specifications may be, e.g., the PHY and MAC specifications defined in, e.g., IEEE 802.15.4/4z. In this disclosure, the UWBS may be referred to as a UWB component.

“UWB-enabled application” may be an application for a service (UWB service). In this disclosure, “UWB-enabled Application” may be abbreviated as an application or a UWB application.

“Service” may be an implementation of a use case that provides a service to an end-user. In this disclosure, the service may be referred to as a UWB service.

“Service data” may be data defined by a service provider that may be transferred between two ranging devices to implement a service.

“Service provider” may be an entity that defines and provides hardware and software provide a specific service to an end-user.

“STS” may be a ciphered sequence for increasing the integrity and accuracy of ranging measurement timestamps.

Unlike “static STS,” “dynamic STS mode” may be an operation mode in which the STS is not repeated during a ranging session. In this mode, the STS may be managed by the ranging device, and the ranging session key for generating STS may be managed by a secure component.

“Static STS mode” is an operation mode in which STS is repeated during a session, and may not be managed by the secure component.

“Secure channel” may be a data channel that prevents overhearing and tampering.

“Secure component” may be an entity (e.g., secure element (SE) or trusted execution environment (TEE)) having a defined security level that interfaces with UWBS for the purpose of providing RDS to UWBS, e.g., when dynamic STS is used.

“Secure ranging” may be ranging based on STS generated through a strong encryption operation.

“UWB channel” may be one of candidate UWB channels allocated for UWB communication. Candidate UWB channels allocated for UWB communication may be channels allocated for UWB communication. The UWB channel may be used for UWB communication (e.g., UWB ranging and/or transaction). For example, the UWB channel may be used for transmission/reception of a ranging frame RFRAME and/or transmission/reception of a data frame. As an embodiment, one or a plurality of UWB channels may be operated together.

“Narrow band (NB) channel” may be a channel having a narrower bandwidth than the UWB channel. As an embodiment, the NB channel may be a subchannel of one of the candidate UWB channels allocated for UWB communication or a channel using a specific bandwidth of another available band (e.g., a portion of an industrial, scientific and medical (ISM) band). Candidate UWB channels allocated for UWB communication may be channels allocated for UWB communication. The NB channel may be used for advertising, device discovery, and/or connection setup for additional parameter negotiation/authentication. For example, the NB channel may be used for transmission and reception of a discovery beacon (message), an advertisement message, an additional advertising message, a connection request message, and/or a connection confirmation message. As an embodiment, one or a plurality of NB channels may be operated together. As an embodiment, the NB channel may be used for in-band communication, like the UWB channel.

“Mirroring channel” may be a channel used to provide information about device-to-device discovery and UWB channel occupancy. The mirroring channel may be one of the NB channels. The mirroring channel may be coupled (or synchronized) with the UWB channel. For discovery, an advertisement message may be transmitted through a mirroring channel. As an embodiment, the advertisement message may be transmitted through the mirroring channel when the UWB channel (communication) is activated (UWB activation case). In this disclosure, the mirroring channel may be referred to as an advertisement channel or an NB advertisement channel or an NB mirroring channel. The advertisement message may be referred to as a first advertisement message or an NB advertisement message. As an embodiment, one or more mirroring channels may be operated together.

“Discovery channel” may be a channel used for device-to-device discovery and connection setup. The discovery channel may be one of the NB channels. The discovery channel may not be coupled (or synchronized) with the UWB channel. For discovery, a discovery beacon (message) may be transmitted through a discovery channel. As an embodiment, the discovery beacon (message) may be transmitted through the discovery channel regardless of whether the UWB channel (communication) is activated. The discovery beacon (message) may be transmitted through the discovery channel not only in the UWB activation case but also in the UWB deactivation case. In this disclosure, the discovery channel may be referred to as an NB discovery channel. The discovery beacon may be referred to as a discovery message, an NB discovery beacon, or an NB discovery message. As an embodiment, one or more discovery channels may be operated together.

When determined to make the subject matter of the disclosure unnecessarily unclear, the detailed description of related known functions or features may be skipped in describing the disclosure.

Hereinafter, various embodiments of the disclosure are described with reference to the accompanying drawings.

FIG. 1A illustrates an example architecture of a UWB device according to an embodiment of the present disclosure.

Referring to FIG. 1A, a UWB device 100a may include at least one PHY layer 110a, a MAC layer (MAC sublayer) 120a and/or a higher layer 130a.

### (1) PHY Layer

At least one PHY layer 110a may include a transceiver with a low-level control mechanism. In this disclosure, the transceiver may be referred to as an RF transceiver or a radio transceiver.

In an embodiment, the at least one PHY layer 110a may include at least one first transceiver supporting a UWB channel and at least one second transceiver supporting an NB channel and/or a Bluetooth low energy (BLE) channel. In this disclosure, the first transceiver may be referred to as a UWB transceiver. The second transceiver may be referred to as an NB transceiver and/or a BLE transceiver.

In another embodiment, at least one PHY layer 110a may include a transceiver (dual-channel transceiver) that supports at least two of the UWB channel, the NB channel, and the BLE channel.

In an embodiment, the PHY layer 110a may support at least one of the following functions:
Transceiver activation and deactivation function (transceiver on/off function);
Energy detection function;
Channel selection function;
Clear channel assessment (CCA) function;
Synchronization function;
Low-level signaling function;
UWB ranging, positioning and localization functions;
Spectrum resource management function; and/or
Function to transmit/receive packets through physical medium.

### (2) MAC Layer

The MAC layer 120a provides an interface between the upper layer 130a and the PHY layer 120a.

In an embodiment, the MAC layer 120a may provide two services as follows:
MAC data service: A service that enables transmission and reception of MAC protocol data unit (PDU) through the PHY; and
MAC management service: Service interfacing to MAC sublayer management entity (MLME) service access point (SAP) (MLME-SAP).

In an embodiment, the MAC layer 120a may support at least one of the following functions:
Device discovery and connection setup function;
Channel access function (function of access to physical channel (e.g., NB channel/UWB channel));
Synchronization function (e.g., synchronization between NB channel (mirroring channel) and UWB channel);
Interference mitigation function based on energy detection;
Functions related to narrowband signaling;
Guaranteed timeslot (GTS) management function;
Frame delivery function;
UWB ranging function;
PHY parameter change notification function; and/or
Security function.

### (3) Upper Layer

The upper layer 130a may include a network layer providing functions, such as network configuration and message routing, and/or an application layer providing an intended function of the device.

In an embodiment, the application layer may be a UWB-enabled application layer for providing a UWB service.

FIG. 1B illustrates a communication system including a UWB device according to an embodiment of the present disclosure.

Referring to FIG. 1B, the communication system 10b may include a first UWB device 100b and a second UWB device 200b. The first UWB device 100b and/or the second UWB device 200b of FIG. 1B may be an example of the UWB device 100a of FIG. 1A.

The first UWB device 100b may include a UWB-enabled application layer 110b, a framework 120b, at least one UWB transceiver 130b, and/or at least one NB and/or BLE transceiver 140b. The second UWB device 200b may include a UWB-enabled application layer 210b, a framework 220b, at least one UWB transceiver 230b, and/or at least one NB and/or BLE transceiver 240b.

In FIG. 1B, the UWB transceiver and the NB and/or BLE transceiver of each device are illustrated as separate components, but the components are divided according to their operations/functions. In other words, the UWB transceiver and the NB and/or BLE transceiver are not limited as implemented as separate physical components (e.g., separate chipsets). Accordingly, the UWB transceiver, the NB transceiver, and the BLE transceiver each may be implemented as a separate chipset, or the UWB transceiver, the NB transceiver, and the BLE transceiver may be implemented as one integrated chipset.

The UWB-enabled application layers 110b and 210b may be upper application layers for UWB services.

The framework 120b or 220b may be an entity that collectively manages the UWB transceiver 130b or 230b and the NB and/or BLE transceiver 140b or 240b. In an embodiment, the framework 120b or 220b may support a function to control UWB/NB/BLE communication (e.g., medium access control (MAC) or UWB/NB/BLE transceiver synchronization function) and/or a function for communicating obtained information to a higher application layer 110b or 210b.

The UWB transceiver 130b or 230b may support at least one of candidate UWB channels allocated for UWB communication. In other words, the UWB transceiver 130b or 230b may support at least one UWB channel. At least one UWB channel supported by the UWB transceiver 130b or 230b or the UWB transceiver 130b or 230b may be used for UWB communication (e.g., UWB ranging and/or transaction). For example, at least one UWB channel supported by the UWB transceiver 130b or 230b or the UWB transceiver 130b or 230b may be used for transmitting/receiving a ranging frame RFRAME and/or a data frame.

The NB and/or BLE transceiver 140b or 240b may support, e.g., at least one NB channel having a narrower bandwidth (e.g., 50 MHz or less) than a UWB channel. At least one channel supported by the NB and/or BLE transceiver 140b or 240b or the NB and/or BLE transceiver 140b or 240b may be used for advertisement (discovery) and/or narrowband signaling.

In an embodiment, the first UWB device 100b and the second UWB device 200b may perform a UWB communication (procedure) (in-band communication) through a first radio link (UWB channel) established through the UWB transceiver 110b of the first UWB device 100b and the UWB transceiver 210b of the second UWB device 200b.

In an embodiment, the first UWB device 100b and the second UWB device 200b may perform an NB communication (procedure) (in-band communication) through a second radio link (NB channel) established through the NB and/or BLE transceiver 110b of the first UWB device 100b and the NB and/or BLE transceiver 210b of the second UWB device 200b.

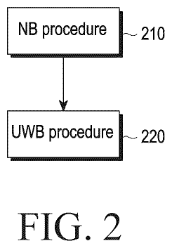

FIG. 2 illustrates a method for performing an NB procedure and a UWB procedure by a UWB device according to an embodiment of the present disclosure.

The UWB device of FIG. 2 may be, e.g., the UWB device of FIG. 1A or 1B.

Referring to FIG. 2, the UWB device may perform the NB procedure 210 and the UWB procedure 220. The NB procedure 210 and UWB procedure 220 may be managed or controlled by the MAC layer (entity) and/or higher layer of the UWB device.

### (1) NB Procedure 210

In the disclosure, the NB procedure 210 means a procedure performed using at least one NB channel. The NB procedure 210 may be performed before the UWB procedure 220.

The NB procedure 210 may include at least one of the following operations:
An operation in which the UWB device transmits and/or receives an advertisement message through at least one initialization channel (advertising operation);
An operation in which the UWB device transmits and/or receives a discovery beacon (message) through at least one discovery channel (discovery operation);
An operation in which the UWB device transmits and/or receives at least one of a poll message, a response message, and a report message during the control phase and/or report phase of the ranging round and/or ranging block in the ranging channel (or one of the NB channels);
An operation in which the UWB device transmits and/or receives an additional advertisement message, a connection request message, and/or a connection confirmation message through at least one connection setup channel or initialization channel;
An operation in which the UWB device transmits and/or receives at least one of an adv poll message, an adv response message, and a start of ranging (SOR) message through the initialization channel;
An operation in which the UWB device transmits and/or receives at least one of an adv confirmation message and a start of ranging (SOR) message through the initialization channel; and/or
An operation in which the UWB device transmits and/or receives a connection request message and/or a connection confirmation message through at least one discovery channel.

### (2) UWB Procedure 220

In the disclosure, the UWB procedure 220 means a procedure performed using at least one UWB channel.

The UWB procedure 220 may include at least one of the following operations:
An operation in which a UWB device performs UWB ranging with another UWB device (UWB ranging operation); and/or
An operation in which a UWB device exchanges service data with another UWB device (transaction operation).

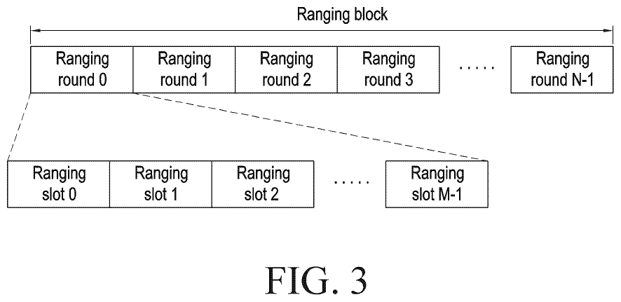

FIG. 3 illustrates an example of a structure of a ranging block and round used for UWB ranging according to an embodiment of the present disclosure.

In this disclosure, the ranging block refers to a time period for ranging. The ranging round may be a period of sufficient duration to complete one entire range-measurement cycle in which a set of UWB devices participating in a ranging exchange involves. The ranging slot may be a sufficient period for transmission of at least one ranging frame (RFRAME) (e.g., ranging initiation/reply/final message, etc.).

As shown in FIG. 3, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds. According to an embodiment, the control message of the controller may include at least one of the number of slots included in the ranging round and the duration of the ranging round. According to an embodiment, the SOR message of the NB may include at least one of the number of slots included in the ranging round and the duration of the ranging round.

In the disclosure, ranging round may be abbreviated as a round, ranging block as a block, and ranging slot as a slot.

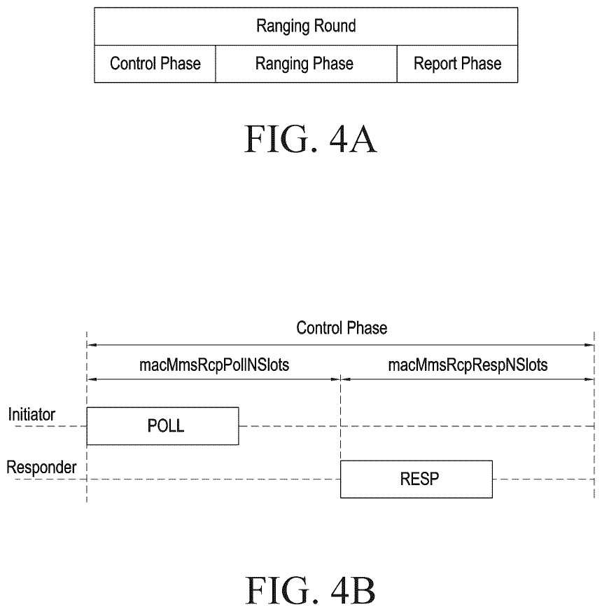

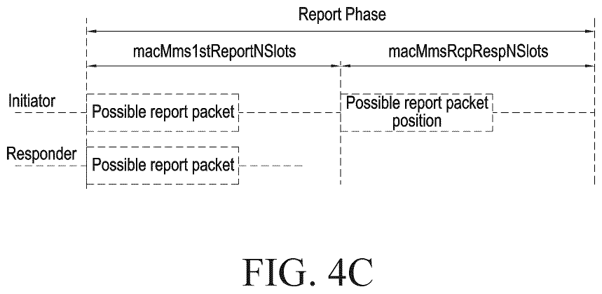

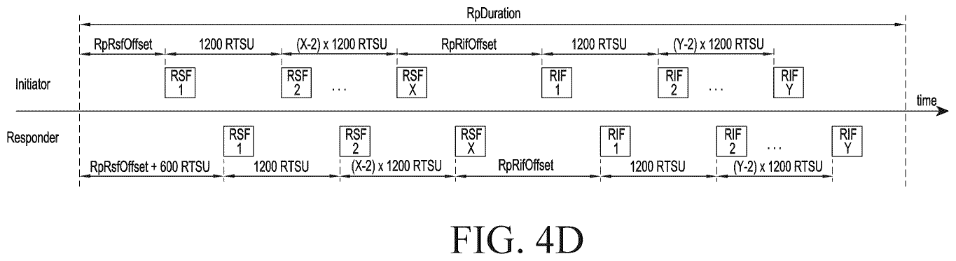

FIG. 4A illustrates an example of a ranging round according to an embodiment of the present disclosure.

Referring to FIG. 4A, a ranging round may be composed of a time period for a control phase, a time period for a ranging phase, and a time period for a report phase. The ranging round illustrated in FIG. 4A may be a structure utilizing a block-based structure as defined in IEEE 802.15.4ab.

For example, the time period for the control phase may include at least one slot for ranging control, the time period for the ranging phase may include at least one slot for ranging, and the time period for the report phase may include at least one slot for the transmission/reception of a measurement report. According to an embodiment, some of the above-described phases may not be included in the ranging round. Additional phases (e.g., ranging control update phase, or ranging interval update phase) may be further included in the ranging round.

According to an embodiment, the control phase may be a phase in which the controller transmits a ranging control message (RCM). The RCM may be a message transmitted by the controller to set ranging parameters. According to an embodiment, the RCM may be transmitted in the first slot (slot #0) of the ranging round.

According to an embodiment, in the case of NB-UWB MMS (Multi-Millisecond), during the control phase, an initiator device may transmit a poll message to a responder device through NB, and the responder device may transmit a response message corresponding to the poll message to the initiator device through NB.

According to an embodiment, the ranging phase may be a phase including a ranging initiation phase, a ranging response phase, and/or a ranging final phase. The ranging initiation phase (RIP) may be a phase in which initiator(s) transmit ranging initiation message(s) to responder(s). The ranging response phase (RRP) may be a phase in which the responder(s) transmit their response message(s) to the initiator. The ranging final phase (RFP) may be a phase in which the initiator transmits final message(s) to responder(s). The ranging final phase may only be used for DS-TWR.

According to an embodiment, in the case of NB-UWB MMS, during the ranging phase, the initiator device and the responder device may transmit and/or receive a ranging sequence fragment (RSF) and/or a ranging integrity fragment (RIF) through UWB.

The report phase may be a phase in which participating ranging devices exchange service information related to ranging measurements.

In FIGS. 4B to 4D, an example of the operation of an initiator device and a responder device according to the IEEE 802.15.4ab standard is described for convenience of description.

FIG. 4B illustrates an example of a control phase in a ranging round according to an embodiment of the present disclosure.

Referring to FIG. 4B, the initiator device may be a device (e.g., ranging device) initiating a ranging exchange, and the responder device may be a device (e.g., ranging device) responding to the initiator in the ranging exchange.

The initiator device may transmit a POLL message in the first slot (macMmsRcpPollNslots) in the control phase. The responder device may transmit an RESP message (response message) in the second slot (macMmsRcpRespNslots) in the control phase.

According to an embodiment, the control phase illustrated in FIG. 4B may be a multi-millisecond (MMS) control phase. In the MMS control phase, an MMS packet introduced to enhance the performance of next-generation UWB in IEEE 802.15.4ab may be transmitted and/or received.

FIG. 4C illustrates an example of a report phase in a ranging round according to an embodiment of the present disclosure.

Referring to FIG. 4C, the initiator device and/or the responder device may transmit a possible report packet in the first slot (macMms1stReportNslots) in the report phase. The initiator device may transmit a possible report packet in the second slot (macMms2ndReportNslots) in the report phase. According to an embodiment, the report phase illustrated in FIG. 4C may be an MMS report phase.

FIG. 4D illustrates an example of a ranging phase in a ranging round according to an embodiment of the present disclosure.

Referring to FIG. 4D, the time period for the ranging phase is set as RpDuration, and in the ranging phase, the initiator device and/or the responder device may transmit a first ranging sequence fragment (RSF). Subsequently, the initiator device and/or responder device may transmit a plurality of RSFs (e.g., a second RSF, . . . , an Xth RSF, where X is an integer of 3 or more). Within the ranging phase, the initiator device and/or the responder device may transmit a first ranging integrity fragment (RIF). Thereafter, the initiator device and/or the responder device may transmit a plurality of RIFs (e.g., a second RIF, . . . , a Yth RIF, where Y is an integer of 3 or more).

Meanwhile, instead of the NB procedure using the NB channel, a method using BLE or BLE long range (BLE LR) technology may be utilized. BLE LR may provide better performance than NB in terms of distance, transmission power, transmission rate, independent ranging possibility, or scalability.

BLE LR may also be referred to as Coded PHY and is a new mode introduced in Bluetooth version 5.0, capable of extending the communication range of a Bluetooth device to more than 1 km. However, when using BLE LR, adjustments to the duty cycle for radio-on time, power consumption, scheduling, and coexistence over the air may be necessary.

The disclosure provides a UWB ranging method based on BLE (or BLE LR) that may replace NB. BLE (or BLE LR) may be designed as a combochip with UWB or may be designed to be tightly synchronized (e.g., with an error level of 20 ppm or less). BLE (or BLE LR) may be operated in a high-power or LR mode to achieve a reach distance at the NB level.

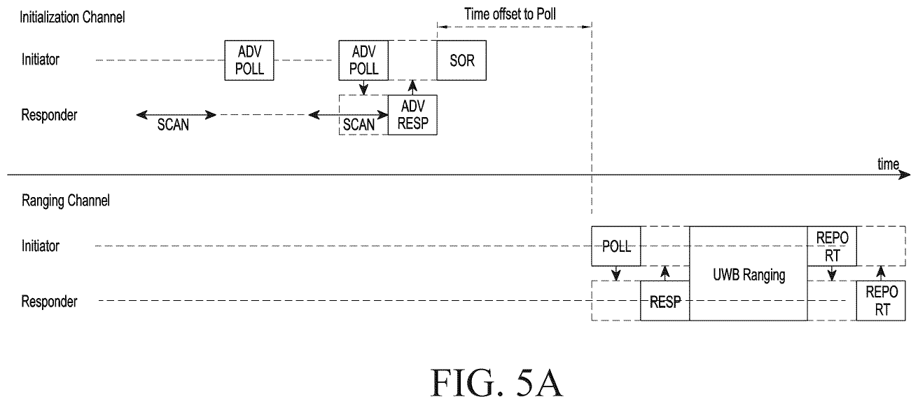

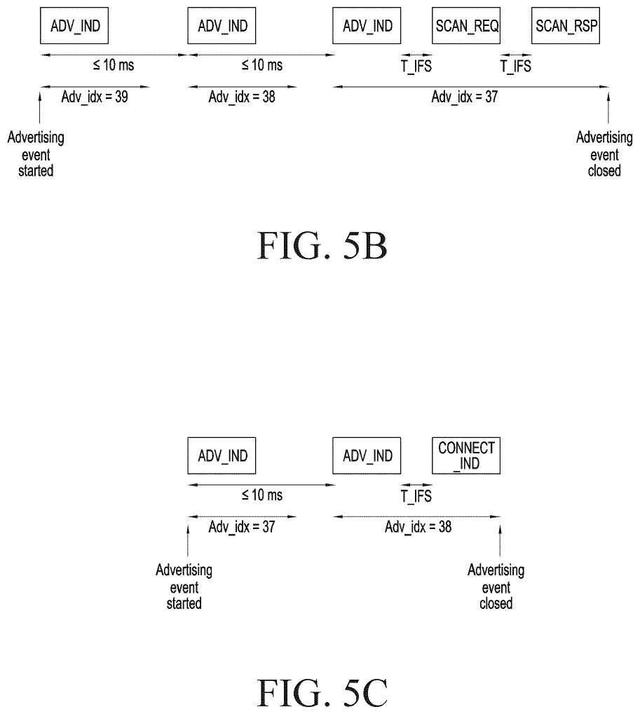

FIG. 5A illustrates an example of an initialization channel and a ranging channel according to an embodiment of the present disclosure.

Referring to FIG. 5A, the initiator device and the responder device may perform an NB, UWB, and/or BLE (or BLE LR) setup procedure (or initialization phase) through the initialization channel. Once the setup procedure is completed, the initiator device and the responder device may perform a UWB ranging procedure through the ranging channel. According to an embodiment, the initialization channel may be implemented as an NB channel, a UWB channel, and/or a BLE (or BLE LR) channel. According to an embodiment, the ranging channel may be implemented as a UWB channel.

Referring to FIG. 5A, the responder device may scan an advertisement poll message within a set time period in an initialization channel and may fail to receive an advertisement poll message as a result of the scan. The initiator device may transmit (or broadcast) an advertisement poll message in the initialization channel. According to an embodiment, the advertisement poll message may be a discovery message (or beacon) transmitted or broadcast by the controller and/or the initiator.

Subsequently, the responder device may scan the advertisement poll message within a set time period in the initialization channel. The responder device may receive the advertisement poll message transmitted by the initiator device based on the scan result. In the initialization channel, the responder device may transmit an advertisement response message corresponding to the advertisement poll message to the initiator device. According to an embodiment, the advertisement response message may be a connection response message of the responder responding to the advertisement poll message.

The initiator device that has received the advertisement response message may transmit a start of ranging (SOR) message in the initialization channel.

When a specific time offset to poll elapses from the time of transmitting the SOR message, the initiator device and the responder device may initiate a UWB ranging procedure in the ranging channel. The initiator device may transmit a poll message for ranging to the responder device in the ranging channel after the specific time offset to poll. The responder device may transmit a response message responding to the poll message to the initiator device in the ranging channel.

The initiator device and the responder device may perform UWB ranging in the ranging channel. The initiator device may transmit a report message to the responder device in the ranging channel. The responder device may transmit a report message to the initiator device in the ranging channel.

FIG. 5B illustrates an example of a UWB setup process through an initialization channel according to an embodiment of the present disclosure.

Referring to FIGS. 5A and 5B, the initiator device (or advertiser device) and the responder device (or scanner device) may perform the UWB setup procedure of FIG. 5B to correspond to the setup specifications through the initialization channel illustrated in FIG. 5A. The ADV_IND packet of FIG. 5B may correspond to the advertisement poll message of FIG. 5A, the SCAN_REQ packet of FIG. 5B may correspond to the advertisement response message of FIG. 5A, and the SCAN_RESP packet of FIG. 5B may correspond to the SOR message of FIG. 5A.

Referring to FIG. 5B, the initiator device (or advertiser device) may transmit or broadcast an ADV_IND packet at least once in the initialization channel. The responder device (or scanner device) may receive an ADV_IND packet within a set time period in the initialization channel. In the initialization channel, the responder device (or scanner device) may transmit a SCAN_REQ packet to the initiator device (or advertiser device) in response to the ADV_IND packet.

The initiator device (or advertiser device) that has received a SCAN REQ packet may transmit a SCAN_RESP packet in the initialization channel.

When a specific time offset elapses from the time of transmitting the SCAN_RESP packet, the initiator device (or advertiser device) and the responder device (or scanner device) may initiate a UWB ranging procedure in the ranging channel.

FIG. 5C illustrates an example of a BLE setup process through an initialization channel according to an embodiment.

Referring to FIGS. 5A and 5C, the initiator device (or advertiser device) and the responder device (or scanner device) may perform a BLE (or BLE LR) setup procedure of FIG. 5C to correspond to the setup specifications through the initialization channel illustrated in FIG. 5A. The ADV_IND packet of FIG. 5C may correspond to an advertisement poll message of FIG. 5A. The CONNECT_IND packet of FIG. 5C may correspond to the advertisement response message of FIG. 5A or may be identical to the existing BLE format.

Referring to FIG. 5C, the initiator device (or advertiser device) may transmit or broadcast an ADV_IND packet at least once in the initialization channel. The responder device (or scanner device) may receive an ADV_IND packet within a set time period in the initialization channel. In the initialization channel, the responder device (or scanner device) may transmit a CONNECT_IND packet to the initiator device (or advertiser device) in response to the ADV_IND packet.

According to an embodiment, the initiator device (or advertiser device) and the responder device (or scanner device) may perform the UWB setup illustrated in FIG. 5B and the BLE (or BLE LR) setup illustrated in FIG. 5C, and subsequently perform the UWB ranging procedure illustrated in FIG. 5A.

According to an embodiment, the ADV_IND packet (or BLE ADV_IND) illustrated in FIG. 5B and/or FIG. 5C may follow the format of the ADV POLL message (or advertising POLL compact frame) illustrated in FIG. 5A. According to an embodiment, the ADV POLL message (or advertising POLL compact frame) may include fields such as RPA hash, RPA Prand, message control, message content, and FCS.

According to an embodiment, the ADV_IND packet may or may not include information of the ADV POLL of NB in the ADV_IND payload. According to an embodiment, RPA Hash and RPA Prand may be unnecessary when using a BLE private address, and RPA Hash and RPA Prand may not be included in the ADV_IND payload. According to an embodiment, when using a separate Security method other than BLE, information of the ADV POLL of NB may be included in the ADV_IND payload. According to an embodiment, the ADV_IND packet may not include an FCS. According to an embodiment, the ADV_IND packet may include a message control and message content corresponding thereto, but may be omitted as NB specific other than 0x00. According to an embodiment, the ADV_IND packet may be sufficient in the existing BLE ADV_IND Format, but an RPA Hash/RPA Prand, generated using another security method composed of BLE pairing-based RPA Hash/RPA Prand (not a BLE private address), may be included in the ADV_IND payload.

According to an embodiment, the SCAN_REQ packet illustrated in FIG. 5B may not include separate data and may be used for responding to the ADV_IND packet and requesting a SCAN RSP packet.

According to an embodiment, the SCAN_RSP packet illustrated in FIG. 5B may follow the format of the SOR message (or start of ranging compact frame) illustrated in FIG. 5A. According to an embodiment, the SOR message (or start of ranging compact frame) may include RPA Hash, RPA Prand, message control, message content, and FCS fields. According to an embodiment, the message content may include at least one of a time offset, NB channel seed, NB channel map, management PHY configuration, management MAC configuration, ranging (UWB) PHY configuration, and ranging (UWB) MAC configuration fields.

According to an embodiment, the SCAN_RSP packet may include at least one of time offset, NB channel seed, NB channel map, management PHY configuration, management MAC configuration, Ranging (UWB) PHY configuration, and ranging (UWB) MAC configuration fields. According to an embodiment, the SCAN RSP packet may not include NB-related parameters (e.g., NB channel seed, NB channel map, management PHY configuration, management MAC configuration) during BLE-based ranging. According to an embodiment, when using NB after BLE setup, the SCAN_RSP packet may include NB-related parameters (e.g., NB channel seed, NB channel map, management PHY configuration, management MAC configuration).

According to an embodiment, the SCAN_RSP packet may include 31 octets of data. According to an embodiment, the SCAN_RSP packet may include UWB PHY/MAC configuration information (e.g., ranging (UWB) PHY configuration field, and/or ranging (UWB) MAC configuration field). According to an embodiment, the SCAN_RSP packet may include a time offset, and the time offset may indicate a starting point of a first block for UWB. According to an embodiment, after BLE setup, if there are various Trigger types such as NB/Wi-Fi/UWB, the SCAN_RSP packet may include a separate delimiter for distinguishing various Trigger types such as NB/Wi-Fi/UWB.

According to an embodiment, the CONNECT_IND packet illustrated in FIG. 5C may be configured in a BLE Format. According to an embodiment, the starting point of the “BLE connection event” indicated by a TransmitWindowDelay/Offset/Window representing an interval between the ADV event and the connection event, and the “first block starting point of UWB” indicated by the “time offset” value of SCAN_RSP may be the same or different.

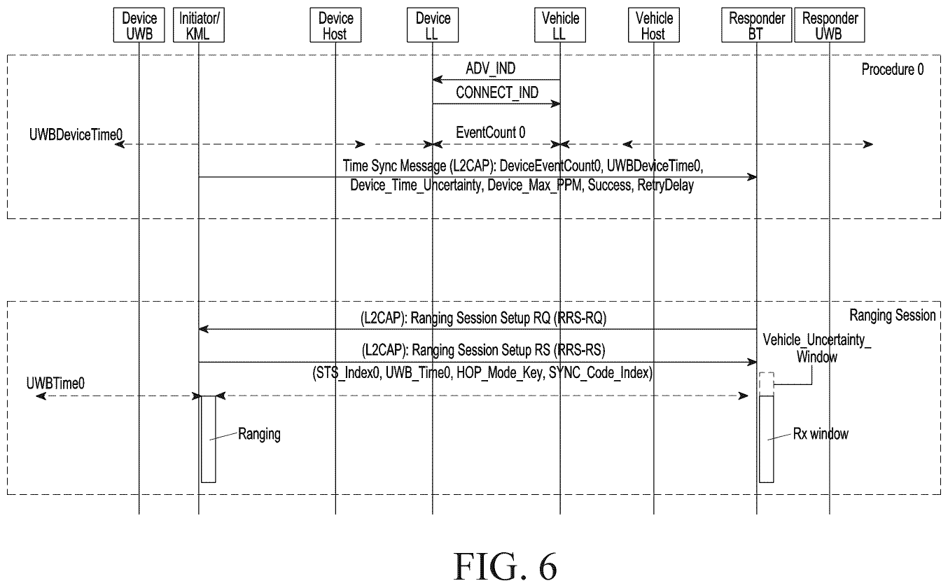

FIG. 6 illustrates an example of a BLE session setup process according to an embodiment of the present disclosure.

The BLE session setup process provided in the disclosure may replace the NB session setup process of IEEE 802.15 4ab. During BLE connection and UWB ranging session setup, additional design for a Discovery-Connection-Ranging setup process may not be performed, and the time sync level (e.g., 20 ppm) between BLE/UWB may be negligible.

Referring to FIG. 6, a system for BLE session setup may include a first device (including device UWB, initiator/KML, device host, and device LL), a second device (including vehicle LL and vehicle host), and a third device (including responder BT and responder UWB). Device LL may be a BLE module in the first device, device host may be a BLE higher layer in the first device, device UWB may be a UWB module in the first device, and initiator/KML may be a digital key framework in the first device as higher entities (which may be at, e.g., an operating system (OS) level) of both BLE and UWB. Vehicle LL may be a BLE module in the second device, and vehicle host may be a BLE higher layer in the second device. responder BT may be a BLE module in the third device, and responder UWB may be a UWB module in the third device.

Vehicle LL may transmit the ADV_IND packet to device LL, and device LL may transmit a CONNECT_IND packet corresponding to the ADV_IND packet to Vehicle LL. Vehicle LL and device LL may transmit and/or receive EventCount 0. initiator/KML may transmit a time sync message through logical link control and adaption protocol (L2CAP) to responder BT. According to an embodiment, the time sync message (L2CAP) may include at least one of DeviceEventCount0, UWBDeviceTime0, Device_Time_Uncertainty, Device_Max_PPM, success, and RetryDelay.

In the ranging session, responder BT may transmit a ranging session setup request message (RSS-SQ) to initiator/KML through L2CAP. Initiator/KML may transmit a ranging session setup response message (RSS-RS) to responder BT through L2CAP. According to an embodiment, the ranging session setup response message (RSS-RS) may include at least one of STS_Index0, UWB_Time0, HOP_Mode_Key, and SYNC_Code_Index.

According to an embodiment, a ranging setup (ranging setup interval) may operate according to the specifications of IEEE 15.4z or 4ab, and during IEEE 15.4ab setup, the whole or part of the ADV_RSP/SOR information may be included.

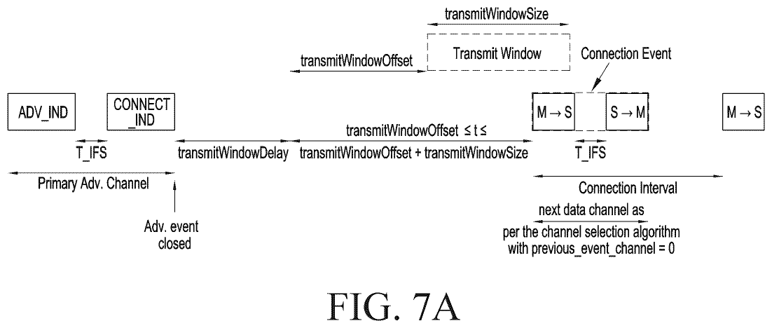

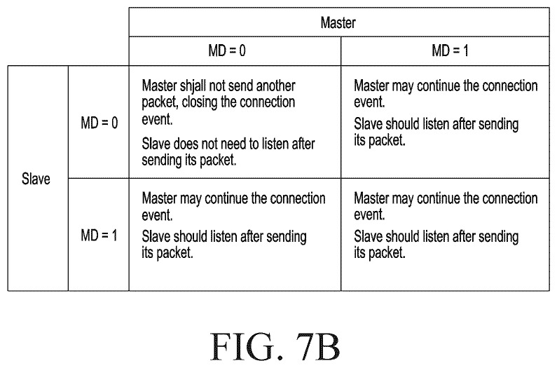

FIG. 7A illustrates an example in which an advertising event and a connection event are performed on a BLE protocol according to an embodiment of the present disclosure, and FIG. 7B illustrates an example of a more data (MD) bit indicating whether there is more data transmitted by a device according to an embodiment of the present disclosure.

Referring to FIG. 7A, the initiator device (or advertiser device) may transmit (or broadcast) an advertising packet. The responder device (or scanner device) may receive the advertising packet within a set time period. The responder device (or scanner device) may transmit a CONNECT_IND packet to the initiator device (or advertiser device) after a set time period (T_IFS) in response to the advertising packet.

When the advertising event is terminated, a connection event may be performed after a time t in a set delay time transmitWindowDelay and a set range transmitWindowOffset≤t≤transmitWindowOffset+transmitWindowSize. According to an embodiment, transmitWindowSize may refer to the size of the Transmit Window.

In the connection event, a master device (or initiator device) and a slave device (or responder device) may transmit and/or receive data (or PDU) in the connection interval. In the connection state, the master device (or initiator device) and the slave device (or responder device) may exchange PDU in the connection interval units. According to an embodiment, whether the connection event is terminated in the connection interval may be controlled by the more data (MD) bit in FIG. 7B.

Referring to FIG. 7B, the MD bit included in the header of the PDU may indicate whether there is more data to be transmitted by the device. If the MD bit of the master device is set to 0 and the MD bit of the slave device is set to 0, the master device may terminate the connection event without transmitting another packet, and the slave device may not perform a listen operation after packet transmission. If the MD bit of the master device is set to 0 and the MD bit of the slave device is set to 1, the master device may continue the connection event, and the slave device may perform a listen operation after packet transmission. If the MD bit of the master device is set to 1 and the MD bit of the slave device is set to 0, the master device may continue the connection event, and the slave device may perform a listen operation after packet transmission. If the MD bit of the master device is set to 1 and the MD bit of the slave device is set to 1, the master device may continue the connection event, and the slave device may perform a listen operation after packet transmission.

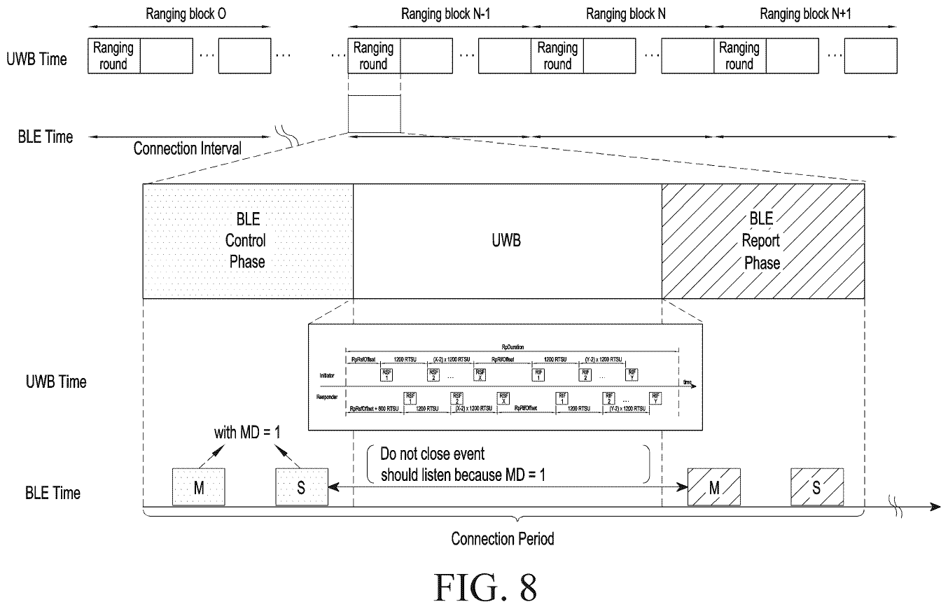

FIG. 8 illustrates an example of ranging using BLE communication and UWB communication according to an embodiment of the present disclosure.

To perform the BLE (or BLE LR)-based UWB ranging provided in the disclosure, it is necessary to synchronize the UWB Time for UWB communication and the BLE Time for BLE (or BLE LR) communication. FIG. 8 illustrates an example in which a BLE (or BLE LR)-based control phase (BLE control phase), a UWB-based ranging phase, and a BLE (or BLE LR)-based report phase (BLE report phase) are performed. Referring to FIG. 8, the block length of the ranging block defined in UWB communication and the connection interval defined in BLE (or BLE LR) communication may be set to occupy the same time period. Further, the round length of the ranging round defined in UWB communication and the connection period of the connection event defined in BLE (or BLE LR) communication may be set to occupy the same time period.

### <BLE (or BLE LR)-Based Control Phase (BLE Control Phase)>

Each of the master device (or initiator device) and the slave device (or responder device) may set the MD bit to indicate that there is more data to transmit (e.g., set as MD=1) and may exchange BLE messages. According to an embodiment, the master device (or initiator device) and the slave device (or responder device) may exchange BLE messages instead of NB poll/response/report messages. According to an embodiment, the master device (or initiator device) and/or the slave device (or responder device) may transmit a BLE message including information about the start time of the UWB-based ranging phase.

### <UWB-Based Ranging Phase>

The time period for the UWB-based ranging phase may be set to RpDuration, and in the ranging phase, the initiator device and/or responder device may transmit a first RSF. Subsequently, the initiator device and/or responder device may transmit a plurality of RSFs (e.g., a second RSF, . . . , an Xth RSF, where X is an integer of 3 or more). Within the ranging phase, the initiator device and/or responder device may transmit a first RIF. Thereafter, the initiator device and/or the responder device may transmit a plurality of RIFs (e.g., a second RIF, . . . , a Yth RIF, where Y is an integer of 3 or more).

### <BLE (or BLE LR)-Based Report Phase (BLE Report Phase)>

In the BLE (or BLE LR)-based control phase (BLE control phase), each of the master device (or initiator device) and the slave device (or responder device) set the MD bit to indicate that there is more data to transmit (e.g., set as MD=1), and in the BLE (or BLE LR)-based report phase (BLE report phase), the master device (or initiator device) and/or the slave device (or responder device) may receive BLE messages transmitted from another device without terminating the connection event.

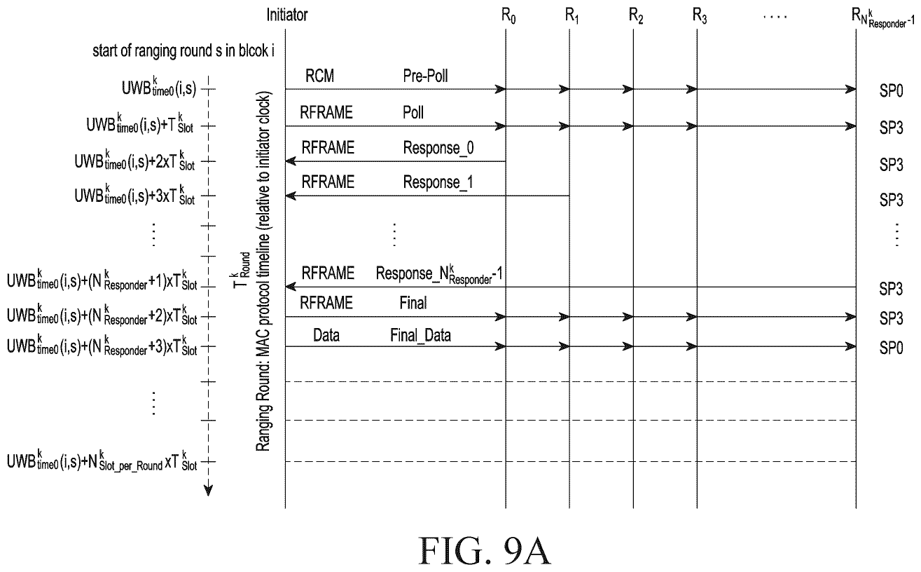

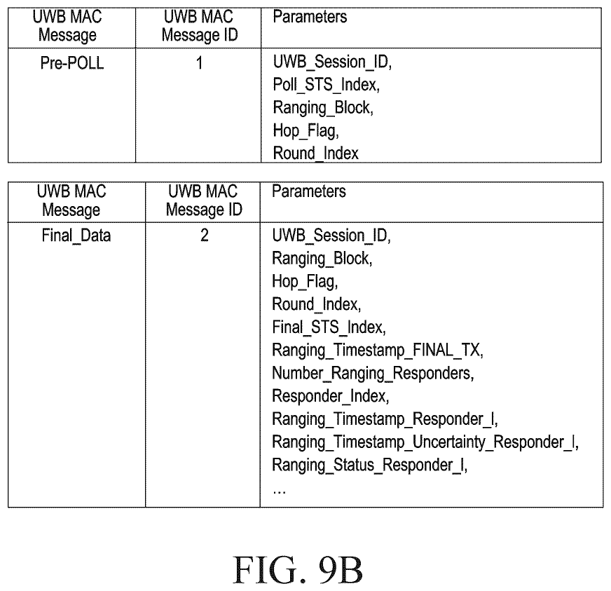

FIGS. 9A and 9B illustrate an example of a method of replacing an NB on a BLE protocol according to an embodiment of the present disclosure.

Referring to FIGS. 9A and 9B, the initiator device may transmit a pre-poll message, and a plurality of responder devices

$$( {R}_{0} to {R}_{{N}_{\text{?}}^{k} - 1} )$$

$$\text{?} \text{indicates text missing or illegible when filed}$$

may receive the pre-poll message. According to an embodiment, the pre-poll message may include information about the start time of the UWB ranging phase. According to an embodiment, the pre-poll message may include an MD bit indicating that there is data to transmit (e.g., set as MD=1). According to an embodiment, the UWB MAC message ID for the pre-poll message may be set to, e.g., 1. According to an embodiment, the pre-poll message may include at least one parameter among UWB_Session_ID, Poll_STS_Index, Ranging_Block, Hop_Flag, and Round_Index. According to an embodiment, the pre-poll message may be utilized for data transmission in the car connectivity consortium (CCC).

According to an embodiment, at least one of the plurality of responder devices

$$( {R}_{0} to {R}_{{N}_{\text{?}}^{k} - 1} )$$

$$\text{?} \text{indicates text missing or illegible when filed}$$

may transmit an ACK message for the pre-poll message on at least one ranging slot (between the pre-poll message and the poll message). According to an embodiment, some of the plurality of responder devices

$$( {R}_{0} to {R}_{{N}_{\text{?}}^{k} - 1} )$$

$$\text{?} \text{indicates text missing or illegible when filed}$$

may omit the transmission of the ACK message.

The initiator device may transmit a poll message, and the plurality of responder devices

$$( {R}_{0} to {R}_{{N}_{\text{?}}^{k} - 1} )$$

$$\text{?} \text{indicates text missing or illegible when filed}$$

may receive the poll message. At least one of the plurality of responder devices

$$( {R}_{0} to {R}_{{N}_{f}^{k} - 1} )$$

may transmit a response message (Response_0) to the initiator device.

The initiator device may transmit a final message, and the plurality of responder devices

$$( {R}_{0} to {R}_{{N}_{\text{?}}^{k} - 1} )$$

$$\text{?} \text{indicates text missing or illegible when filed}$$

may receive the final message.

The initiator device may transmit a Final_Data message, and the plurality of responder devices

$$( {R}_{0} to {R}_{{N}_{\text{?}}^{k} - 1} )$$

$$\text{?} \text{indicates text missing or illegible when filed}$$

may receive the Final_Data message. According to an embodiment, the Final_Data message may include an MD bit indicating that there is no data to be transmitted (e.g., set as MD-0). According to an embodiment, the UWB MAC message ID for the Final_Data message may be set to, e.g., 2. According to an embodiment, the Final_Data message may include at least one parameter among UWB_Session_ID, Ranging_Block, Hop_Flag, Round Index, Final_STS_Index, Ranging_Timestamp_FINAL_TX, Number_Ranging_Responders, responder_Index, Ranging_Timestamp_responder_1, Ranging_Timestamp_Uncertainty_responder_1, and Ranging_Status_responder_1. According to an embodiment, the Final_Data message may be utilized for data transmission in the car connectivity consortium (CCC).

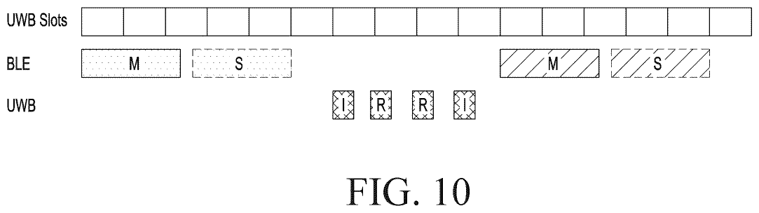

FIG. 10 illustrates an example in which a plurality of slots are used as a BLE transmission period according to an embodiment of the present disclosure.

Meanwhile, due to the use of Coded PHY, the data rate may be low or the packet may be long, and thus the length of a UWB ranging slot may not be sufficient for BLE packet transmission. In this case, BLE packet (poll or response or report) transmission may not be possible in a single UWB ranging slot.

Referring to FIG. 10, the UWB ranging slot is merely a time unit for UWB operation, and a plurality of UWB ranging slots may be set as a BLE transmission period. According to an embodiment, the master device (or initiator device) may transmit a BLE packet (poll or report) during the plurality of UWB ranging slots. According to an embodiment, the slave device (or responder device) may transmit a BLE packet (response or report) during the plurality of UWB ranging slots.

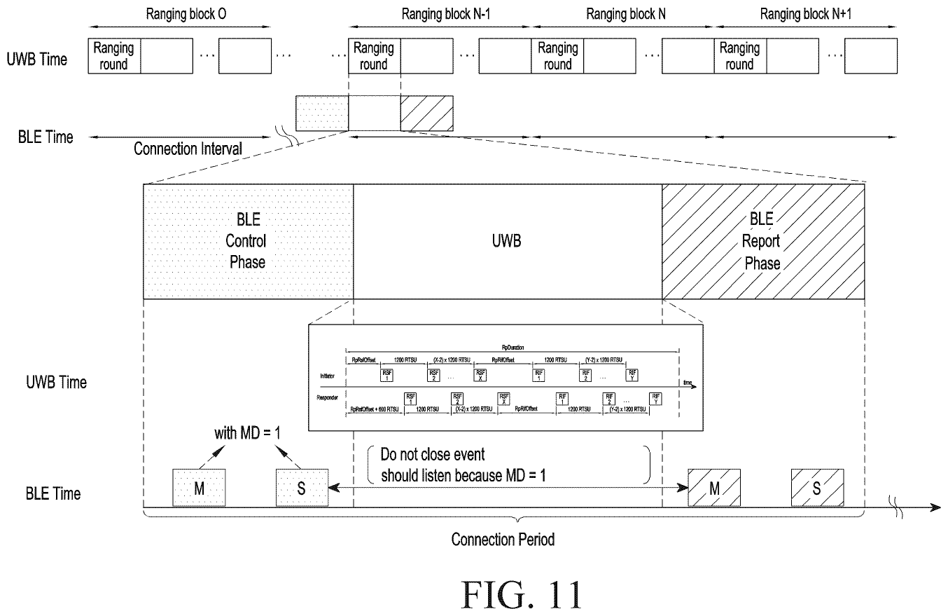

FIG. 11 illustrates an example of ranging using BLE communication and UWB communication according to an embodiment of the present disclosure.

FIG. 11 illustrates an example in which a BLE (or BLE LR)-based control phase (BLE control phase), a UWB-based ranging phase, and a BLE (or BLE LR)-based report phase (BLE report phase) are performed.

Referring to FIG. 11, the block length of the ranging block defined in UWB communication and the connection interval defined in BLE (or BLE LR) communication may be set to occupy the same time period. Further, the length of the ranging round defined in UWB communication may be set to occupy the same time period as the period allocated to the UWB-based ranging phase. Unlike FIG. 8, in the embodiment of FIG. 11, the time (connection period) of the connection event defined in BLE (or BLE LR) communication may be set to be longer than the length (round length) of the ranging round defined in UWB communication.

According to an embodiment, one ranging round may be allocated to the UWB-based ranging phase, and a time period for the BLE (or BLE LR)-based control phase (BLE control phase) may be allocated before the ranging round, and a time period for the BLE (or BLE LR)-based report phase (BLE report phase) may be allocated after the ranging round.

According to an embodiment, the time period (connection period) of the connection event defined in BLE (or BLE LR) communication may be equal to the sum of the ranging round allocated to the UWB-based ranging phase, the time period for the BLE (or BLE LR)-based control phase (BLE control phase), and the time period for the BLE (or BLE LR)-based report phase (BLE report phase) (connection event period=round length+BLE control/report phase).

According to an embodiment, when disposing BLE transmission before/after the UWB ranging round, the start time of the BLE control phase may be earlier than the initial ranging block time.

According to an embodiment, the message exchanged during the ranging setup process may include at least one of information regarding the start time of the UWB block and information regarding the start time of the BLE transmission. According to an embodiment, a pre-poll message or poll message may include at least one of information regarding the start time of the UWB block or information regarding the start time of the BLE transmission. In other words, since the start of the BLE transmission may precede the start of the UWB block, a separate parameter (e.g., BLETime0) may be added during the ranging setup process to distinguish the start times of BLE and UWB. A BLE/UWB synchronization procedure may be performed through BLE transmission (pre-poll or poll/response) in the control phase. According to an embodiment, a pre-poll message or poll message or response message may include information regarding the start time of the UWB ranging phase (ranging phase).

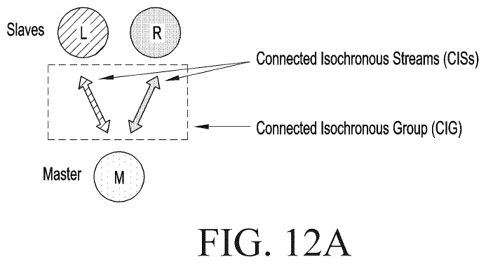

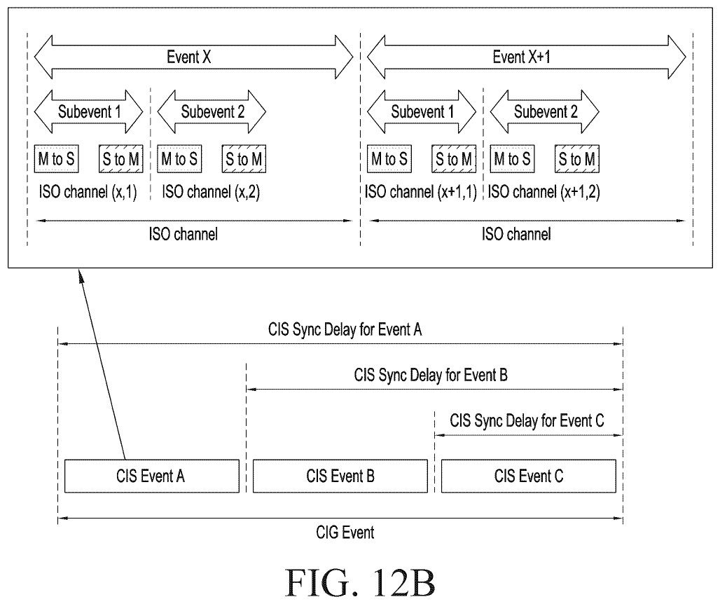

FIG. 12A illustrates an example of devices for a connected isochronous stream (CIS) according to an embodiment of the present disclosure.

An embodiment relates to a method for an electronic device to transmit and/or receive audio data with an external electronic device using BLE communication, wherein electronic devices of Bluetooth Core Version 5.2 or higher may support audio services through the connected isochronous stream (CIS) method. When supporting audio services through the CIS method, the electronic device may connect a CIS link for delivering audio data to the external electronic device using BLE communication, and the settings at the time of CIS link connection may remain fixed until the CIS link is released.

Referring to FIG. 12A, a first CIS may be established between the master device M and a first slave device L, and a second CIS may be established between the master device M and a second slave device R. The first CIS and the second CIS may be referred to as a connected isochronous group (CIG). For example, the master device M may be implemented as a portable communication device (e.g., a smartphone), and the first slave device L and the second slave device R may be implemented as a pair of wireless earphones worn on the user's left ear and right ear, respectively. According to an embodiment, the master device M may transmit and/or receive signals and/or data with each of the first slave device L and the second slave device R.

FIG. 12B illustrates an example of a CIS event according to an embodiment of the present disclosure.

Referring to FIG. 12B, a CIG event may include a plurality of CIS events (CIS event A to CIS event C). A CIG sync delay for a CIG event may occur and/or be set, a CIS sync delay for event A may occur and/or be set for CIS event A, a CIS sync delay for event B may occur and/or be set for CIS event B, and a CIS sync delay for event C may occur and/or be set for CIS event C.

In each subevent in a CIS event, a first device may perform the role of a master device during communication based on a CIS scheme, and a second device may perform the role of a slave device during communication based on a CIS scheme.

Referring to FIG. 12B, each of a first CIS event (event x) and a second CIS event (event x+1) in an ISO Interval may include a first subevent and a second subevent. In each of the first subevent and the second subevent, the master device may transmit at least one packet to the slave device (M to S), and the slave device may transmit at least one packet to the master device (S to M).

According to an embodiment, a CIG is constituted by a plurality of CISs, and the timing reference of the CISs in the CIG is identical, and the timing reference may be utilized for synchronization and/or data processing (e.g., audio rendering). According to an embodiment, an ISO Interval (e.g., in a range of 5 ms to 4 seconds, in units of 1.25 ms) may be maintained between CIS events. According to an embodiment, the channel may change for each subevent, and the master device and the slave device may each perform a transmission once (Bi-Directional). According to an embodiment, when only a pre-poll is transmitted like a CCC, the transmission from the slave device to the master device (S to M) may be omitted. According to an embodiment, when there is no ACK message from the slave device in the subevent, a retransmission by the master device may be performed. According to an embodiment, the master device may configure a plurality of CIGs and may include up to 31 CISs per CIG.

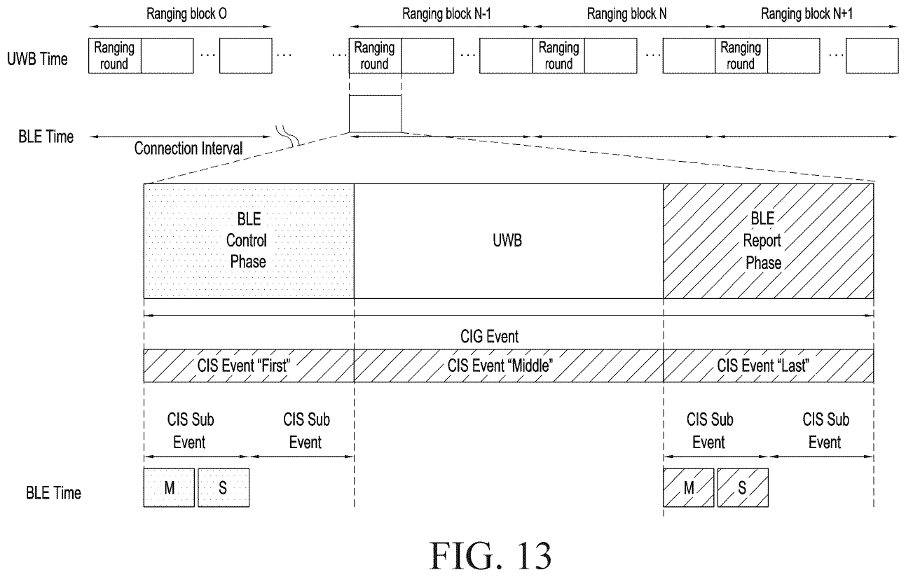

FIG. 13 illustrates an example of ranging using BLE communication and UWB communication according to an embodiment of the present disclosure.

Referring to FIG. 13, the block length of the ranging block defined in UWB communication and the connection interval defined in BLE (or BLE LR) communication may be set to occupy the same time period. Further, the round length of the ranging round defined in UWB communication and the time of the CIG event defined in the CIS may be set to occupy the same time period.

FIG. 13 illustrates an example in which a BLE (or BLE LR)-based control phase (BLE control phase), a UWB-based ranging phase, and a BLE (or BLE LR)-based report phase (BLE report phase) are performed. According to an embodiment, a CIG event may include a first CIS event (CIS event “First”), a second CIS event (CIS event “Middle”), and a third CIS event (CIS event “Last”). According to an embodiment, a BLE (or BLE LR)-based control phase (BLE control phase) may be allocated to the first CIS event (CIS event “First”), a UWB based ranging phase may be allocated to the second CIS event (CIS event “Middle”), and a BLE (or BLE LR)-based report phase (BLE report phase) may be allocated to the third CIS event (CIS event “Last”). According to an embodiment, the second CIS event (CIS event “Middle”) may be constituted by a plurality of CIS events.

### <BLE (or BLE LR)-Based Control Phase (BLE Control Phase)>

In the first CIS subevent in the first CIS event (CIS event “First”), the master device (or initiator device) and the slave device (or responder device) may exchange BLE messages instead of NB poll/response/report messages. According to an embodiment, the master device (or initiator device) and/or the slave device (or responder device) may transmit a BLE message including information regarding the start time of the UWB based ranging phase (or the start time of the second CIS event (CIS event “Middle”)).

### <UWB-Based Ranging Phase>

In the second CIS event (CIS event “Middle”), the master device (or initiator device) and/or the slave device (or responder device) may transmit and/or receive messages for UWB based ranging.

### <BLE (or BLE LR)-Based Report Phase (BLE Report Phase)>

In the first CIS subevent in the third CIS event (CIS event “Last”), the master device (or initiator device) and the slave device (or responder device) may exchange BLE messages for reporting.

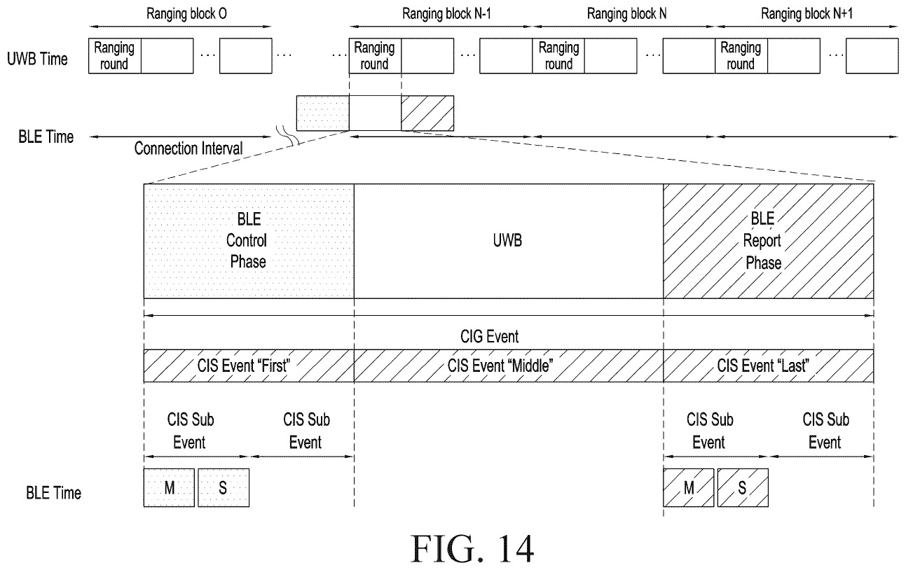

FIG. 14 illustrates an example of ranging using BLE communication and UWB communication according to an embodiment of the present disclosures.

Referring to FIG. 14, according to an embodiment, a CIG event may include a first CIS event (CIS event “First”), a second CIS event (CIS event “Middle”), and a third CIS event (CIS event “Last”). According to an embodiment, a BLE (or BLE LR)-based control phase (BLE control phase) may be allocated to the first CIS event (CIS event “First”), a UWB based ranging phase may be allocated to the second CIS event (CIS event “Middle”), and a BLE (or BLE LR)-based report phase (BLE report phase) may be allocated to the third CIS event (CIS event “Last”). According to an embodiment, the second CIS event (CIS event “Middle”) may be constituted by a plurality of CIS events.

The block length of the ranging block defined in UWB communication and the connection interval defined in BLE (or BLE LR) communication may be set to occupy the same time period. Further, the length of the ranging round defined in UWB communication may be set to occupy the same time period as the period allocated to the UWB-based ranging phase. Unlike FIG. 13, in the embodiment of FIG. 14, the time of the CIG event defined in the CIS may be set to be longer than the length (round length) of the ranging round defined in the UWB communication.

According to an embodiment, one ranging round may be allocated to the UWB-based ranging phase, and a time period for the BLE (or BLE LR)-based control phase (BLE control phase) may be allocated before the ranging round, and a time period for the BLE (or BLE LR)-based report phase (BLE report phase) may be allocated after the ranging round.

According to an embodiment, the time period of the CIG event defined in the CIS may be equal to the sum of the ranging round allocated to the UWB-based ranging phase, the time period for the BLE (or BLE LR)-based control phase (BLE control phase), and the time period for the BLE (or BLE LR)-based report phase (BLE report phase).

According to an embodiment, when disposing BLE transmission before/after the UWB ranging round, the start time of the BLE control phase may be earlier than the initial ranging block time. According to an embodiment, the message exchanged during the ranging setup process may include at least one piece of information regarding the start time of the UWB block and information regarding the start time of the BLE transmission.

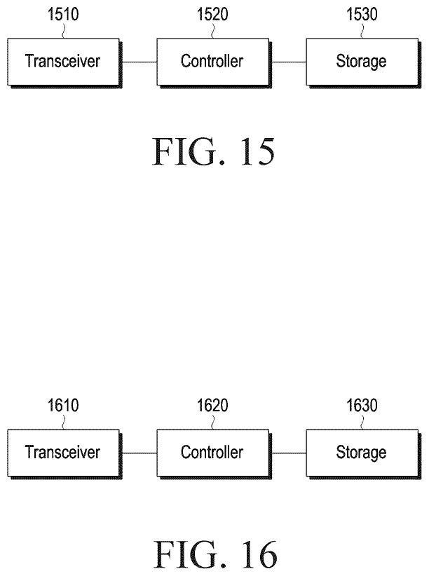

FIG. 15 illustrates a structure of a first UWB device according to an embodiment of the present disclosure.

In the embodiment of FIG. 15, the first UWB device may correspond to the UWB device of FIG. 1, include a UWB device, or may be an electronic device that may include a portion of a UWB device.

In the embodiment of FIG. 15, the first UWB device may be a UWB device serving as an initiator device, master device, and/or controller.

Referring to FIG. 15, the first UWB device may include a transceiver 1510, a controller 1520, and a storage 1530. In the disclosure, the controller may be defined as a circuit, an application-specific integrated circuit, or at least one processor.

The transceiver 1510 may transmit and receive a signal to and from another device. The transceiver 1510 may transmit/receive data to/from another device using, e.g., at least one NB channel, at least one BLE channel, and/or at least one UWB channel.

In an embodiment, the transceiver 1510 may include at least one first transceiver supporting the NB channel and/or BLE channel and at least one second transceiver supporting the UWB channel. In another embodiment, the transceiver 1510 may include at least one transceiver supporting at least two of the NB channel, BLE channel, and UWB channel.

The controller 1520 may control the overall operation of the electronic device according to an embodiment. For example, the controller 1520 may control inter-block signal flow to perform the operations according to the above-described flowchart. Specifically, the controller 1520 may control the operations of the first UWB device described above with reference to FIGS. 1 to 14.

The storage 1530 may store at least one of information transmitted/received via the transceiver 1510 and information generated via the controller 1520. For example, the storage 1530 may store information and data necessary for the method described above with reference to FIGS. 1 to 14.

According to an embodiment, the controller 1520 included in the first UWB device may control to transmit a control message to a second UWB device using Bluetooth low energy (BLE) communication in a control phase for UWB ranging. The controller 1520 may control to transmit a first message to the second UWB device using UWB communication in a ranging phase for the UWB ranging. The controller 1520 may receive a second message corresponding to the first message from the second UWB device using the UWB communication in the ranging phase for the UWB ranging. The controller 1520 may control to transmit a report message to the second UWB device using the BLE communication in a report phase for the UWB ranging.

According to an embodiment, the control phase, the ranging phase, and the report phase may be performed within one ranging round.

According to an embodiment, the control phase may be performed in at least a portion of a first ranging round, the ranging phase may be performed in an entire second ranging round subsequent to the first ranging round, and the report phase may be performed in at least a portion of a third ranging round subsequent to the second ranging round.

According to an embodiment, a plurality of ranging slots may be allocated in at least one of the control message and the report message.

According to an embodiment, a connection interval used in the BLE communication may be set as a time period of the same length as a ranging block used in the UWB communication. According to an embodiment, a connection period of a connection event used in the BLE communication may be set as a time period of the same length as a ranging round used in the UWB communication.

FIG. 16 illustrates a structure of a second UWB device according to an embodiment of the present disclosure.

In the embodiment of FIG. 16, the first UWB device may correspond to the UWB device of FIG. 2, include a UWB device, or may be an electronic device that may include a portion of a UWB device.

In the embodiment of FIG. 16, the second UWB device may be a UWB device serving as a responder device, slave device, and/or controlee.

Referring to FIG. 16, the second UWB device may include a transceiver 1610, a controller 1620, and a storage 1630. In the disclosure, the controller may be defined as a circuit, an application-specific integrated circuit, or at least one processor.

The transceiver 1610 may transmit and receive a signal to and from another device. The transceiver 1610 may transmit/receive data to/from another device using, e.g., at least one NB channel, at least one BLE channel, and/or at least one UWB channel.

In an embodiment, the transceiver 1610 may include at least one first transceiver supporting the NB channel and/or BLE channel and at least one second transceiver supporting the UWB channel. In another embodiment, the transceiver 1610 may include at least one transceiver supporting at least two of the NB channel, BLE channel, and UWB channel.

The controller 1620 may control the overall operation of the electronic device according to an embodiment. For example, the controller 1620 may control inter-block signal flow to perform the operations according to the above-described flowchart. Specifically, the controller 1620 may control the operations of the second UWB device described above with reference to FIGS. 1 to 14.

The storage 1630 may store at least one of information transmitted/received via the transceiver 1610 and information generated via the controller 1620. For example, the storage 1630 may store information and data necessary for the method described above with reference to FIGS. 1 to 14.

According to an embodiment, the controller 1620 included in the second UWB device may receive a control message from a first UWB device using Bluetooth low energy (BLE) communication in a control phase for UWB ranging. The controller 1620 may receive a first message from the first UWB device using UWB communication in a ranging phase for the UWB ranging. The controller 1620 may control to transmit a second message corresponding to the first message to the first UWB device using the UWB communication in the ranging phase for the UWB ranging. The controller 1620 may receive a report message from the first UWB device using the BLE communication in a report phase for the UWB ranging.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a first ultra-wideband (UWB) device, the method comprising:
transmitting, to a second UWB device, a control message using a Bluetooth low energy (BLE) communication in a control phase for UWB ranging;
transmitting, to the second UWB device, a first message using a UWB communication in a ranging phase for the UWB ranging;
receiving, from the second UWB device, a second message corresponding to the first message using the UWB communication in the ranging phase for the UWB ranging; and
transmitting, to the second UWB device, a report message using the BLE communication in a report phase for the UWB ranging.

2. The method of claim 1, wherein the control phase, the ranging phase, and the report phase are configured within one ranging round.

3. The method of claim 1, wherein the control phase is configured in at least a portion of a first ranging round, the ranging phase is configured in a second ranging round subsequent to the first ranging round, and the report phase is configured in at least a portion of a third ranging round subsequent to the second ranging round.

4. The method of claim 1, wherein a plurality of ranging slots is allocated in at least one of the control message or the report message.

5. The method of claim 1, wherein a connection interval used in the BLE communication is set to a time period of a same length as a ranging block used in the UWB communication, and
wherein a connection period of a connection event used in the BLE communication is set to a time period of the same length as a ranging round used in the UWB communication.

6. A method of a second ultra-wideband (UWB) device, the method comprising:
receiving, from a first UWB device, a control message using Bluetooth low energy (BLE) communication in a control phase for UWB ranging;
receiving, from the first UWB device, a first message using a UWB communication in a ranging phase for the UWB ranging;
transmitting, to the first UWB device, a second message corresponding to the first message using the UWB communication in the ranging phase for the UWB ranging; and
receiving, from the first UWB device, a report message using the BLE communication in a report phase for the UWB ranging.

7. The method of claim 6, wherein the control phase, the ranging phase, and the report phase are configured within one ranging round.

8. The method of claim 6, wherein the control phase is configured in at least a portion of a first ranging round, the ranging phase is configured in a second ranging round subsequent to the first ranging round, and the report phase is configured in at least a portion of a third ranging round subsequent to the second ranging round.

9. The method of claim 6, wherein a plurality of ranging slots is allocated in at least one of the control message or the report message.

10. The method of claim 6, wherein a connection interval used in the BLE communication is set to a time period of a same length as a ranging block used in the UWB communication, and
wherein a connection period of a connection event used in the BLE communication is set to a time period of the same length as a ranging round used in the UWB communication.

11. A first ultra-wideband (UWB) device, the first UWB device comprising:
a transceiver; and
a controller coupled with the transceiver, the controller configured to:
transmit, to a second UWB device, a control message using a Bluetooth low energy (BLE) communication in a control phase for UWB ranging;
transmit, to the second UWB device, a first message using a UWB communication in a ranging phase for the UWB ranging;
receive, from the second UWB device, a second message corresponding to the first message using the UWB communication in the ranging phase for the UWB ranging; and
transmit, to the second UWB device, a report message using the BLE communication in a report phase for the UWB ranging.

12. The first UWB device of claim 11, wherein the control phase, the ranging phase, and the report phase are configured within one ranging round.

13. The first UWB device of claim 11, wherein the control phase is configured in at least a portion of a first ranging round, the ranging phase is configured in a second ranging round subsequent to the first ranging round, and the report phase is configured in at least a portion of a third ranging round subsequent to the second ranging round.

14. The first UWB device of claim 11, wherein a plurality of ranging slots is allocated in at least one of the control message or the report message.

15. The first UWB device of claim 11, wherein a connection interval used in the BLE communication is set to a time period of a same length as a ranging block used in the UWB communication, and
wherein a connection period of a connection event used in the BLE communication is set to a time period of the same length as a ranging round used in the UWB communication.

16. A second ultra-wideband (UWB) device, the second UWB device comprising:
a transceiver; and
a controller coupled with the transceiver, the controller configured to:
receive, from a first UWB device, a control message using a Bluetooth low energy (BLE) communication in a control phase for UWB ranging;
receive, from the first UWB device, a first message using a UWB communication in a ranging phase for the UWB ranging;
transmit, to the first UWB device, a second message corresponding to the first message using the UWB communication in the ranging phase for the UWB ranging; and
receive, from the first UWB device, a report message using the BLE communication in a report phase for the UWB ranging.

17. The second UWB device of claim 16, wherein the control phase, the ranging phase, and the report phase are configured within one ranging round.

18. The second UWB device of claim 16, wherein the control phase is configured in at least a portion of a first ranging round, the ranging phase is configured in a second ranging round subsequent to the first ranging round, and the report phase is configured in at least a portion of a third ranging round subsequent to the second ranging round.

19. The second UWB device of claim 16, wherein a plurality of ranging slots is allocated in at least one of the control message or the report message.

20. The second UWB device of claim 16, wherein a connection interval used in the BLE communication is set to a time period of a same length as a ranging block used in the UWB communication, and
wherein a connection period of a connection event used in the BLE communication is set to a time period of the same length as a ranging round used in the UWB communication.
